(19) United States
(12) Patent Application Publication
(10) Pub. No.: US 2026/0238003 A1
(43) Pub. Date: Aug. 13, 2026

(54) CHARGING SYSTEM WITH MULTIPLE CHARGING RECTIFIER CABINETS PARALLEL CONNECTED THEREOF

(71) Applicant: SHENZHEN HB ELECTRONIC CO., LTD, Shenzhen (CN)

(72) Inventor: Jianjun XU, Shenzhen (CN)

(73) Assignee: SHENZHEN HB ELECTRONIC CO., LTD, Shenzhen (CN)

(21) Appl. No.: 19/645,190

(22) Filed: Apr. 12, 2026

Related U.S. Application Data
(63) Continuation-in-part of application No. 18/432,116, filed on Feb. 5, 2024.

(30) Foreign Application Priority Data
Dec. 8, 2025 (CN) 202511845636.0

(51) Int. Cl. H02J 1/10; B60L 53/16; B60L 53/30; B60L 53/62; H02J 1/102; H02J 7/70

(52) U.S. Cl. CPC H02J 1/106; B60L 53/16; B60L 53/30; B60L 53/62; H02J 1/102; H02J 7/70; H02J 2207/20

(57) ABSTRACT

The present disclosure provides a charging system with multiple charging rectifier cabinets parallel connected thereof including X charging rectifier cabinets and a changing unit including a charging gun and a charging control unit configured to detect charging parameters of the charging gun, wherein X is equal to and greater than 2; each of the X charging rectifier cabinets including a power control unit, N power modules and a power distribution matrix circuit with N charging interfaces and a plurality of controlled switch units, the N charging interfaces connected to the N power modules via the plurality of controlled switch units, the power control unit configured to generate multiple groups of switch signals based on the charging parameters, and each group of switch signals configured to control the plurality of controlled switch units within the power distribution matrix circuit to be turned on or turned off.

### 1. CROSS-REFERENCE TO RELATED APPLICATIONS

This application is a continuation-in-part of U.S. application Ser. No. 18/432,116, filed on Feb. 5, 2024. This application claims priority to Chinese Application No. 202511845636.0, filed on Dec. 8, 2025. The entire contents of all of the above-identified patent applications are incorporated herein by reference.

### 2. TECHNICAL FIELD

The present disclosure relates to the field of charging technologies, and more particularly, to a charging system with multiple charging rectifier cabinets parallel connected thereof.

### 3. BACKGROUND

In recent years, an energy storage market, including new energy vehicles, has grown rapidly, and charging piles have become an important link and a basis guarantee in the energy storage market. A rapid development of the energy storage market has also put forward higher requirements for a construction of charging piles.

In a related art, a charging system includes a charging rectifier cabinet and a charging pile, the charging rectifier cabinet mainly consists of two parts that are an AC/DC power conversion and a DC output control. A charging gun is arranged on the charging pile. A plurality of charging guns within this charging system is connected to the charging rectifier cabinet, and a plurality of power modules is equipped within the charging rectifier cabinet, the plurality of power modules is electrically connected to the plurality of charging guns in one-to-one correspondence. A charging vehicle can be connected to the charging gun for being charged, and has a rated charging power. The rated charging power refers to the maximum charging power that is allowed to be connected to the charging vehicle for ensuring safety when the charging vehicle is charged. When the charging gun is inserted into the charging vehicle, at least two situations are occurred below: firstly, when the maximum charging power provided by the charging gun does not meet the rated charging power of the vehicle, for example, the rated charging power of the charging vehicle is 100 KW, but the maximum charging power of the charging gun that is connected to the power module can only provide 60 KW, at this time, the charging vehicle can't be charged according to the rated charging power of the charging vehicle, and has to extend a charging time thereof. Moreover, the vehicle can't yet draw the power from other idle charging guns because all charging guns and all power modules are connected one-to-one, it is impossible to obtain the power of two power modules from one charging gun. Secondly, when the maximum charging power that can be provided by the charging gun is greater than the rated charging power of the charging vehicle, for example, if the rated charging power of the vehicle is 50 KW and the maximum charging power of the power module can only provide 60 KW, then the charging gun can still only charge the vehicle according to the charging power of 50 KW, and the remaining power of 10 KW of the charging gun can't be distributed to other charging guns, resulting in resource waste.

In addition, one charging rectifier cabinet includes the plurality of power modules, and a sum of the maximum charging power of the plurality of power modules is the maximum charging power that can be provided by the charging rectifier cabinet. When the rated charging power of the charging vehicle exceeds the maximum charging power of the charging rectifier cabinet, regardless of whether the charging vehicle is connected to any charging gun, the charging vehicle can't be charged from the charging pile according to the rated charging power thereof.

Therefore, based on the above content, it can be seen that there is an urgent need to provide a charging system that can conveniently and quickly improve the charging power of the charging vehicle when a single charging rectifier cabinet can't meet the rated charging power demand of the charging vehicle, and can adaptively distribute the charging powers of the plurality of charging guns.

### SUMMARY

An objective of the present disclosure is to provide a charging system with multiple charging rectifier cabinets parallel connected thereof which can solve the above technical problem of the related art that a conventional integral charging system is unable to implement intelligent power distribution during charging new energy vehicles.

To achieve the above objective, one aspect of the present disclosure provides a charging system with multiple charging rectifier cabinets parallel connected thereof including:
X charging rectifier cabinets, wherein X is a natural number and equal to and greater than 2; each of the X charging rectifier cabinets including a power control unit, a power distribution matrix circuit and N power modules, wherein N is a natural number and equal to and greater than 2; the power distribution matrix circuit electrically connected to the power control unit, and the N power modules configured to supply a charging power to the charging system; the power distribution matrix circuit including N charging interfaces and a plurality of controlled switch units, the N charging interfaces connected to the N power modules via the plurality of controlled switch units, the plurality of controlled switch units arranged in an N*N matrix, each of the N charging interfaces connected to the N power modules via the N controlled switch units in a row, and each of the N power modules connected to the N charging interfaces via the N controlled switch units in a column, each controlled switch unit arranged at a connection point of each row and column of the N*N matrix, and configured to control the power module in a current column to conduct with the charging interface in a current row; the power control unit configured to real-time control the plurality of controlled switch units to be turned on or turned off, so as to adjust the number of power modules that are conducted with each charging interface;
a changing unit electrically connected to the X charging rectifier cabinets and including a plurality of charging terminals, a charging control unit and a charging gun arranged within each of the plurality of charging terminals, wherein there are N charging guns arranged in the changing unit; and wherein in the same charging terminal, the charging control unit is electrically connected to the charging gun, and the charging control unit is configured to detect the charging parameters of the charging gun in real time; and wherein
each of the N charging guns is connected to the X charging rectifier cabinets, and connected to any charging interface within each of the X charging rectifier cabinets; and wherein
each of the plurality of charging control units is electrically connected to the X power control units of the X charging rectifier cabinets, and the X power control units that are arranged in the X charging rectifier cabinets are electrically connected to each other; and wherein
the charging control unit is configured to send the detected charging parameters of each charging gun to the power control unit, at least one of the X power control units is configured to generate X groups of switch signals based on the charging parameters and send each group of switch signals one-to-one to the power distribution matrix circuit that is within each of the X charging rectifier cabinets; and wherein each group of switch signals is configured to control the plurality of controlled switch units that is within each charging rectifier cabinet to be turned on or turned off, so that the N power modules within each charging rectifier cabinet are conductive or non-conductive with the charging gun; and wherein
under the control of the X groups of switch signals, the X power distribution matrix circuits is configured to enable the N charging guns to meet at least one of the following requirements:
a) at least one of the N charging guns is conducted with j power modules, wherein j is a natural number that satisfies: 1≤j≤N*X; and
b) any of the N charging guns is non-conductive with all of the N*X power modules of the charging system.

The present disclosure provides the advantages as below:
the present disclosure provides the charging system with multiple charging rectifier cabinets parallel connected thereof that the N charging guns are configured to charge the energy storage unit that is connected to the charging gun. When the charging gun is connected to the energy storage unit, the charging control unit starts to obtain the rated charging power of the energy storage unit, and sends the rated charging power of the energy storage unit to at least one power control unit that is received in each charging rectifier cabinet, the power control unit controls the power distribution status of the power distribution matrix circuit that is connected between the N charging modules and the N charging guns. The power control unit controls the power distribution matrix circuit: that is, the power control unit generates multiple groups of switch signals, each group of switch signals configured to control one power distribution matrix circuit, the power distribution matrix circuit controls at least one controlled switch unit to be conducted according to a corresponding switch signal, and one or more power modules are connected in parallel to the charging gun that is connected to the energy storage unit, thereby enabling the energy storage unit to obtain a larger charging power. When the other or more energy storage units continue to be connected to other charging guns, the power control unit further controls the controlled switch units that are correspondingly connected to the other or more charging guns, thereby adjusting the number of power modules that are conducted by the other or more energy storage units, so that all energy storage units can obtain a larger charging power as much as possible, thereby achieving a purpose of intelligently distributing the charging power of the multiple charging guns.

Specifically, when the rated charging power of the energy storage unit is greater than the sum of the maximum charging power of all N power modules within the charging rectifier cabinet, the multiple groups of switch signals generated by the power control unit can control the multiple charging rectifier cabinets separately, so that all N power modules within at least one of multiple charging rectifier cabinets are all connected to the energy storage unit. While, some or all of the power modules in the other or more charging rectifier cabinets are conductively connected to the energy storage unit under the control of the other group or more groups of switch signals to supplement the charging power that is obtained by the energy storage unit from a single charging rectifier cabinet, so that the energy storage unit can be charged at the rated charging power thereof.

For example, each charging rectifier cabinet includes six power modules, each power module has a maximum charging power of 60 KW, and there are two charging rectifier cabinets. When the energy storage unit with a rated charging power of 480 KW is connected to the charging gun, all six power modules within a first charging rectifier cabinet are turned on and connected to the charging gun under the control of a first group of switch signals. At this time, the maximum charging power that can be provided to the charging gun and the energy storage unit that is connected to the charging gun is 360 KW. A second charging rectifier cabinet selects two out of six power modules to be conducted with the charging gun that is connected to the same energy storage unit under the control of a second group of switch signals. Since the first charging rectifier cabinet and the second charging rectifier cabinet are connected in parallel, that is, the N charging interfaces connected to the same charging gun are connected in parallel, so that a superimposed charging power can be provided for the charging gun. Therefore, the charging power that is provided by the second charging rectifier cabinet is 120 KW. In this way, it can be seen that both the first charging rectifier cabinet and the second charging rectifier cabinet jointly provide 480 KW of charging power for the charging gun, which can precisely meet the rated charging power of the energy storage unit.

Therefore, it can be seen that the multiple charging rectifier cabinets that are connected in parallel can overcome the technical problem that a single charging rectifier cabinet can't charge the energy storage unit with the full power greater than the maximum charging power of the charging rectifier cabinet.

In addition, when at least two or more energy storage units are connected to the charging gun, the charging control unit detects the rated charging power of the energy storage unit required on each charging gun that is connected to the energy storage unit, and sends the rated charging power that is required by each charging gun to the power control unit. The power control units within each charging rectifier cabinet are connected in communication with each other, and at least one of the X power control units configured to generate X groups of switch signals. The X groups of switch signals are respectively sent to the power distribution matrix unit within each charging rectifier cabinet, so as to adaptively control the number of power modules conducted with each charging gun that is connected to the energy storage unit, so that each charging gun that is connected to the energy storage unit can obtain the rated charging power suitable for the energy storage unit separately.

Compared with the conventional technical solution that one charging gun is corresponding to one power module, the charging power of the power module in the related art is fixed, and it is impossible to dynamically adjust the charging power that is correspondingly provided to each charging gun. When the rated charging power of the energy storage unit is less than the charging power of the power module, the excess charging power of the power module can't be distributed to other charging guns. In the present disclosure, when the rated charging power of the energy storage unit that is connected to one charging gun is not greater than the maximum charging power of the charging rectifier cabinet, the charging rectifier cabinet will distribute a suitable charging power to the energy storage unit. The excess charging power exceeding the rated charging power of the energy storage unit can be distributed to other charging guns that are connected to the energy storage unit by the charging rectifier cabinet, which is conducive to improving the charging efficiency of multiple energy storage units.

In the present disclosure, each charging control unit detects the charging power of each charging gun in real time, and the at least one control unit configured to generate the X groups of switch signals in real time to control the working status of the controlled switch units within the X power distribution matrix circuits, and switch the number of power modules that are conducted with each charging interface in real time. By combining the above working states with the power distribution matrix circuits, the charging power of all energy storage units that are connected to the charging gun can be dynamically adjusted. Every time a new energy storage unit is connected to the charging gun, the charging power of all N charging guns can be adjusted in a timely manner, so that the multiple energy storage units can be charged more efficiently to reduce the situation where the remaining charging power is not utilized.

### BRIEF DESCRIPTION OF THE DRAWINGS

FIG. 1 is a schematic structural diagram of a charging system with only one charging rectifier cabinet according to an embodiment of the present disclosure;

FIG. 2 is an electrical schematic diagram of a power distribution matrix circuit of the present disclosure;

FIG. 3 is a schematic diagram of a simplified matrix layout of the power distribution matrix circuit of FIG. 2;

FIG. 4 is an equivalent circuit diagram of an one-to-one connection between a charging interface, a controlled switch unit and a power module of the power distribution matrix circuit of the present disclosure;

FIG. 5 is a schematic diagram of a charging system with X charging rectifier cabinets according to an embodiment of the present disclosure; and

FIG. 6 is a schematic diagram of a charging system with two charging rectifier cabinets according to an embodiment of the present disclosure.

FIG. 7 is a schematic diagram of a charging system with two charging rectifier cabinets according to another embodiment of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples. According to the described exemplary embodiment of the present disclosure, all other embodiments obtained by one of ordinary skilled in the related art on the premise of no creative work are within the protection scope of the present disclosure.

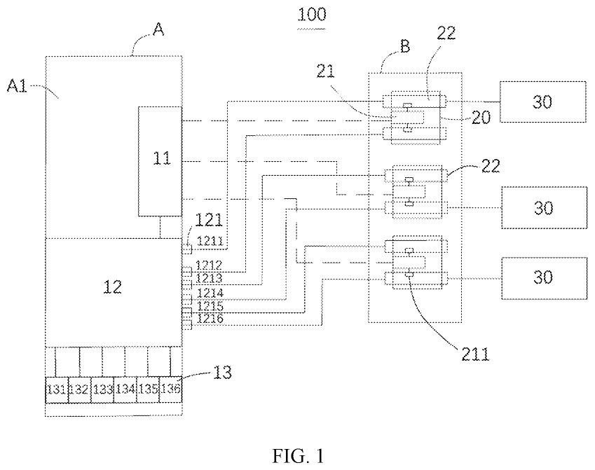

Referring to FIG. 1, a charging system with multiple charging rectifier cabinets parallel connected thereof 100 according to an embodiment of the present disclosure is provided. The charging system 100 includes:

### A Charging Rectifier Cabinet A

The charging rectifier cabinet A is configured to receive a power control unit 11, a power distribution matrix circuit 12 and N power modules 13 therein, wherein N is natural number that satisfies N≥2. The power distribution matrix circuit 12 is electrically connected to the power control unit 11 and the N power modules 13, the N power modules 13 configured to supply a charging power to the charging system. The power distribution matrix circuit 12 includes N charging interfaces 121 and a plurality of controlled switch units 122, the N charging interfaces 121 connected to the N power modules 13 via the plurality of controlled switch units 122. The power control unit 11 is configured to real-time control a working state of the power distribution matrix circuit 12, that is, by controlling the plurality of controlled switch units 122 to be turned on or turned off, to achieve changes of the working state of the power distribution matrix circuit 12. Under the control of the power control unit 11, the power distribution matrix circuit 12, controls the plurality of controlled switch units 122 to be turned on or turned off, thereby adjusting the number of power modules 13 that is conductively connected to each charging interface 121.

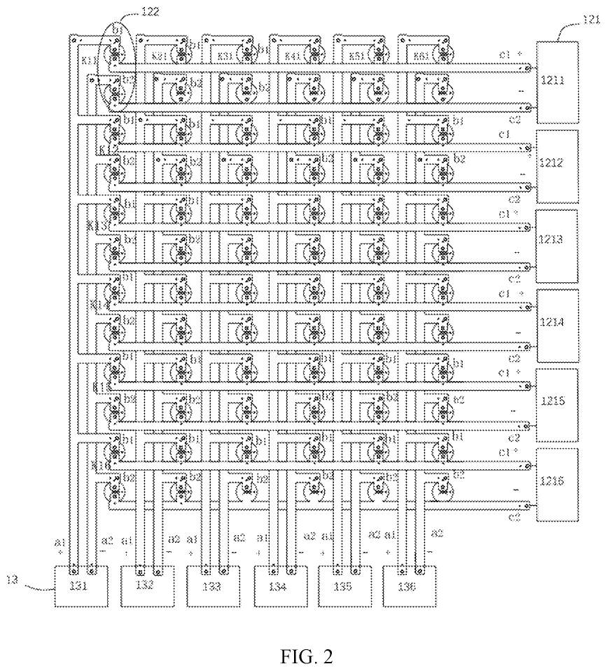

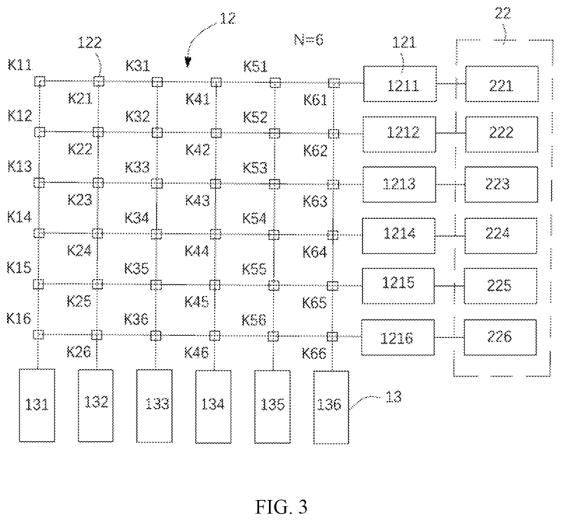

Referring to FIG. 2 and FIG. 3, in the present disclosure, the power distribution matrix circuit 12 includes N*N controlled switch units 122 arranged in an N*N matrix, each controlled switch unit 122 located at a connection point of each row and each column of the N*N matrix. Each of the N charging interfaces 121 is connected to the N power modules 13 via N controlled switch units 122 in a row, and each of the N power modules 13 is connected to the N charging interfaces 121 via N controlled switch units 122 in a column. Each controlled switch unit 122 is configured to control the power module 13 where the current column is located to conduct with the charging interface 121 where the current row is located.

The N power modules 13 are respectively taken as a first module 131, a second module 132, an M-th module until to an N-th module. A maximum charging power output by the first module 131, the second module 132, the M-th module until to the N-th module is taken as Q1, Q2, Qm until to Qn, wherein N is an integer greater than or equal to 2, M≤N, m≤. The N charging interfaces 121 are respectively taken as a first interface 1211, a second interface 1212, an M-th interface until to an N-th interface.

In the present disclosure, the N charging interfaces 121 are arranged in columns, and the N power modules 13 are arranged in rows, the first module 131 connected to the first interface 1211 through a corresponding controlled switch unit 122, the first module 131 connected to the second interface 1212 through a corresponding controlled switch unit 122, the first module 131 connected to the third interface 1213 through a corresponding controlled switch unit 122, until the first module connected to the N-th interface 1211 through a corresponding controlled switch unit 122.

In the present disclosure, the second module 132 is connected to the first interface 1211 through a corresponding controlled switch unit 122, the second module 132 connected to the second interface 1212 through a corresponding controlled switch unit 122, the second module 132 connected to the third interface 1213 through a corresponding controlled switch unit 122, until the second module 132 connected to the N-th interface through a corresponding controlled switch unit 122.

In the present disclosure, the N-th module is connected to the first interface 1211 through a corresponding controlled switch unit 122 by using a similar connection method as described above, and the N-th module is connected to the second interface 1212 through a corresponding controlled switch unit 122 until the N-th module is connected to the N-th interface through a corresponding controlled switch unit 122.

Therefore, it can be seen that there are N*N controlled switch units 122 within a charging rectifier cabinet A, and the N charging interfaces 121 are connected to the N power modules 13 through the N*N controlled switch units 122.

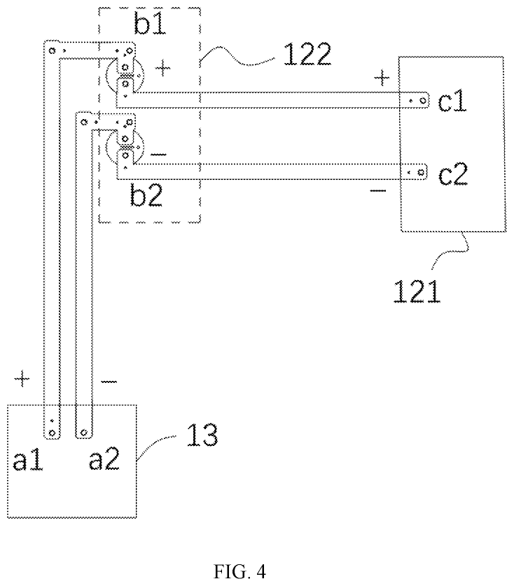

Referring to FIG. 4, in the present disclosure, each power module 13 includes a charging positive electrode a1 and a charging negative electrode a2, each charging interface 121 including a positive terminal c1 and a negative terminal c2, each controlled switch unit 122 including a positive switch b1 and a negative switch b2, wherein the charging positive electrode a1 is connected to the positive terminal c1 through the positive switch b1, and the charging negative electrode a2 is connected to the negative terminal c2 through the negative switch b2; and wherein when both the positive switch b1 and the negative switch b2 of each controlled switch unit are turned on, the power module 13 is electrically connected to the charging interface 121.

### A Charging Unit B

Referring to FIG. 1, the charging unit B includes a plurality of charging terminals 20, a charging control unit 21 and a charging gun 22 arranged within each of the plurality of charging terminals 20, wherein there are N charging guns 22 arranged in the changing unit B; and wherein in the same charging terminal 20, the charging control unit 21 is electrically connected to the charging gun 22, and the charging control unit 21 is configured to detect the charging parameters of the charging gun 22 in real time.

Each charging gun 22 is electrically connected to both the positive terminal c1 and the negative terminal c2. When the charging gun 22 is inserted into an energy storage unit 30, the positive terminal c1 and the negative terminal c2 become conductive with each other, and the charging gun 22 obtains a charging power from the charging interface 121.

When only one charging gun 22 is set in each charging terminal 20, the charging system has N charging terminals 20, and the charging control unit 21 within each of the N charging terminals 20 is configured to detect the charging parameters of the charging gun 22. When each charging terminal 20 is equipped with two charging guns 22, the charging system has N/2 charging terminals 20, wherein N is an even number. The charging control unit 21 within each of the N/2 charging terminals 20 is configured to detect the charging parameters of the two charging guns 22. Of course, the number of charging guns 22 within each charging terminal 20 can also be three, four, or more. In the present disclosure, the preferred number of charging guns 22 within each charging terminal 20 is two.

Although the number of charging guns 22 in the same charging terminal 20 can be two or more, the charging power among the plurality of charging guns 22 in the same charging terminal 20 does not interfere with each other. In addition, the charging parameters of the plurality of charging guns 22 are independently detected by the charging control unit 21 and do not interfere with each other. It can be understood that the charging control unit 21 has a detection terminal 211. In the charging terminal 21, the number of detection terminals 211 is the same as that of charging guns 22, and each detection terminal 211 is connected to one charging gun 22. When there are two charging guns 22 within the same charging terminal 20, the charging control unit 21 has two detection terminals 211 respectively connected to the two charging guns 22, thereby achieving one-to-one detection of the charging power of each charging gun 22.

Referring to FIG. 1, the charging gun 22 can be connected to an energy storage unit 30 to charge the energy storage unit 30. The charging parameters mainly include charging information of the energy storage unit 30 that is connected to the charging gun 22 and charging information of the charging gun 22. The charging information includes: a rated charging power of the energy storage unit 30 that is connected to the charging gun 22, a current charging voltage of the energy storage unit 30, and a current charging current of the energy storage unit 30. Because the energy storage unit 30 and charging gun 22 are connected with each other, the current charging voltage of the energy storage unit 30 is the same as the current charging voltage of the charging gun 22, while the current charging current of the energy storage unit 30 is the same as the current charging current of the charging gun 22. Specifically, the energy storage unit 30 is equipped with a Battery Management System (BMS) and storage batteries. The BMS is configured to control a voltage and a current of charging and discharging based on performances, a battery temperature, a rated voltage and a rated current of the storage batteries inside the energy storage unit 30. Once the storage batteries are completely manufactured and then the BMS leaves the factory, the batteries under the BMS management have the maximum allowable charging power, the rated current and the rated voltage, wherein the maximum allowable charging power is the rated charging power of the energy storage unit 30. As long as when charging the batteries, the charging power that the charging gun 22 provides to the storage batteries is not greater than the rated charging power, and the charging current and the charging voltage that the charging gun 22 provides to the storage batteries are not greater than the rated current and the rated voltage, there will be no irreparable damage to the storage batteries, and there will be no explosion or combustion caused by thermal failure of the storage batteries. So, before charging the energy storage unit 30, it is necessary to first detect the rated charging power of the energy storage unit 30 through the charging control unit 21, and then ensure the safety during the charging process of the energy storage unit 30.

After the energy storage unit 30 is conductively connected to the charging gun 22, the charging control unit 21 still needs to detect the current charging voltage and the current charging current of the charging gun 22 in real time to ensure that the current charging voltage of the charging gun 22 can't exceed the maximum allowable charging voltage of the battery itself, and the current charging current of the charging gun 22 can't exceed the maximum allowable charging current of the battery itself.

Another scenario is that during the continuous charging process of the energy storage unit 30, as the amount of charged electricity increases, the BMS will also manage, control, and modify the charging voltage and the charging current to keep the charging voltage below a safe charging voltage and the charging current below a safe charging current. The safe charging voltage and the safe charging current can ensure the safety of the battery during continuous charging as the charging capacity increases. So the real-time detection of the charging control unit 21 is also a process that data communication and interaction are occurred between the charging control unit 21 and the BMS battery management system, so that the charging rectifier cabinet A can adjust the charging power, the charging voltage and the charging current of the charging gun 22 in real time, thereby ensuring the charging safety of the energy storage unit 30.

### A Charging Connection Between the Charging Rectifier Cabinet A and the Charging Unit B

Referring to FIG. 1 to FIG. 3, in the present disclosure, one of the N charging interfaces 121 within the charging rectifier cabinet A is connected to any one of the charging guns 22 within the charging unit B, that is, one charging gun 22 is connected to one charging interface 121. Since each charging interface 121 is connected to the N controlled switch units 122, at this time, one charging gun 22 is connected to the N power modules 13 through one charging interface 121 and the N controlled switch units 122. When one of the N controlled switch units 122 is controlled to be turned on, the charging interface 121 that is connected to the N controlled switch units 122 is connected to one power module 13, and the charging gun 22 that is connected to the charging interface 121 and the energy storage unit 30 that is connected to the charging gun 22 obtain the charging power of the power module 13. The maximum charging power of the charging interface 121 corresponds to the maximum charging power of the power module 13 that is conducted. When some of the N controlled switch units 122 are controlled to be turned on, the charging interface 121 that is connected to the N controlled switch units 22 is connected to a plurality of power modules 13, and the charging gun 22 that is connected to the charging interface 121 and the energy storage unit 30 that is connected to the charging gun 22 obtain a sum of the charging power of the plurality of power modules 13 that are conducted. The maximum charging power of the charging interface 121 is the sum of the maximum charging power of the corresponding plurality of power modules 13 that are conducted.

### A Control Connection Between the Charging Rectifier Cabinet A and the Charging Unit B

Referring to FIG. 1 to FIG. 3, the charging control unit 21 within the charging unit B is electrically connected to the power control unit 11 within the charging rectifier cabinet A. The electrical connection here includes a direct electrical connection, a wireless connection, or an indirect connection through a controllable conduction way.

The charging control unit 21 sends the detected charging parameters of each charging gun 22 to the power control unit 11. Based on the charging parameters, the power control unit 11 generates a power distribution strategy with X groups of switch signals C and sends one of the X groups of switch signals C to the power distribution matrix circuit 12. The power distribution strategy controls the power distribution matrix circuit 12 through the group of switch signals C. The X groups of switch signals C are configured to control the N*N controlled switch units 122 within the charging rectifier cabinet A to be turned on or turned off, so that the N power modules 13 within the charging rectifier cabinet A are conductive or non-conductive with one or more charging guns 22.

In the present disclosure, a group of switch signals C has N*N switch control signals C1, each switch control signal C1 configured to control one controlled switch unit 122 to be turned on or turned off, so as to make that the power module 13 where the current controlled switch unit 122 is located in the column, and the charging interface 121 where the current controlled switch unit 122 is located in the row are conductive or non-conductive with each other.

Therefore, it can be seen that the N*N controlled switch units 122 can be controlled by using the N*N switch control signals C1 of the group of switch signals C, thereby controlling the number of power modules 13 that are connected to each charging interface 121 and each charging gun 22. The minimum number of power modules 13 that are connected to the charging interface 121 within the charging rectifier cabinet A is zero, which means that all controlled switch units 122 within the charging rectifier cabinet A are non-conductive. At this time, there is no power output from the charging interface 121, and the charging power of the charging interface 121 is zero. The maximum number of power modules 13 that are connected to the charging interface 121 within the charging rectifier cabinet A is N, which means that all of the N controlled switch units 122 in the same row within the charging rectifier cabinet A are conducted. At this time, the maximum charging power of the charging interface 121 is the sum of the maximum charging power of the N power modules 13. Of course, the number of power modules 13 that are conducted in the same row and connected to the charging interface 121 can also be between 0 and N.

When two or more controlled switch units 122 in the same column are turned on, it will cause one power module 13 to simultaneously supply power to the two or more charging interfaces 121. At this time, if the two or more charging interfaces 121 are connected to two or more energy storage units 30, due to different internal resistances of the two or more energy storage units 30 that are connected to the two or more charging interfaces 121, so that the charging voltages and the charging currents of the two or more energy storage units 30 are not the same. However, the power module 13 itself only outputs the charging voltage and the charging current, and can't adjust itself. Therefore, in this case, it will be impossible to control the charging powers of the two or more energy storage units 30, thereby causing the power of the two or more charging interfaces 121 to be disconnected from the control of the power distribution matrix circuit 12. Therefore, in the power distribution matrix circuit 12, it is not allowed two or more controlled switch units 122 in the same column to be turned on.

In addition, since the charging control unit 21 detects the charging parameters of the charging gun 22 in real time, and the power control unit 11 also receives the charging parameters in real time. The power control unit 11 generates the switch signals C in real time, and the switch signals C controls the conduction and non-conduction of the plurality of controlled switch units 122 in real time. Therefore, at two consecutive time points, the same charging gun 22 is conducted with different numbers of power modules 13 according to different charging amounts of the energy storage units 30 that are connected to the charging gun 22, in order to adapt to charge the energy storage units 30. Or if different energy storage units 30 are connected to different charging guns 22, and these different energy storage units 30 have different amounts of electricity or internal resistances, then these different charging guns 22 are conductive with different numbers of power modules 13 at the same time to adapt to charge these different energy storage units 30.

### A Charging Rectifier Cabinet A of a First Embodiment

In order to provide a clearer explanation of the charging power situations of the charging interface 121 of the first embodiment, it will provide detail description with reference with Table 1 and FIG. 1 to FIG. 3.

Firstly, in the embodiment, if N is equal to 6, the charging rectifier cabinet A includes six charging interfaces 121 respectively taken as a first interface 1211 to a sixth interface 1216. The charging rectifier cabinet A has six power modules 13 respectively taken as a first module 131 to a sixth module 136. The charging unit B has six charging guns 22 respectively taken as a first charging gun 221 to a sixth charging gun 226. The first charging gun 221 is electrically connected to the first interface 1211, the second charging gun 222 is electrically connected to the second interface 1212, and so on until the sixth charging gun 226 is electrically connected to the sixth interface 1216. The maximum charging power of the first module 131 to the sixth module 136 is 10 KW, 20 KW, 30 KW, 40 KW, 50 KW, 60 KW respectively, and the maximum charging power of the charging rectifier cabinet A is 210 KW in total. There are 36 controlled switch units 122 in total, consisting of 6*6, respectively taken as from a switch unit K11 to a switch unit K66. In Table 1, a switch unit K13 represents the controlled switch unit 122 that is located at the connection point between a first column and a first row. Similarly, a switch unit K45 represents the controlled switch unit 122 that is located at the connection point between a fourth column and a fifth row, and so on.

TABLE 1
conduction state and charging power distribution table of
controlled switch unit of power distribution matrix circuit

| | Power module | | | | | | | | | | | | | Maximum |
|---|---|---|---|---|---|---|---|---|---|---|---|---|---|---|
| | First | | Second | | Third | | Fourth | | Fifth | | Sixth | | | charging |
| | module | | module | | module | | module | | module | | module | | Charging | power of |
| | 10 KW | | 20 KW | | 30 KW | | 40 KW | | 50 KW | | 60 KW | | interface | charging gun |
| Status of controlled | K11 | ▪ | K21 | □ | K31 | □ | K41 | □ | K51 | □ | K61 | □ | First | 10 KW |
| switch unit | | | | | | | | | | | | | interface | |
| □ non-conduction | K12 | □ | K22 | ▪ | K32 | □ | K42 | □ | K52 | □ | K62 | □ | Second | 20 KW |
| ▪ conduction | | | | | | | | | | | | | interface | |
| | K13 | □ | K23 | □ | K33 | ▪ | K43 | □ | K53 | □ | K63 | □ | Third | 30 KW |
| | | | | | | | | | | | | | interface | |
| | K14 | □ | K24 | □ | K34 | □ | K44 | ▪ | K54 | □ | K64 | □ | Fourth | 40 KW |
| | | | | | | | | | | | | | interface | |
| | K15 | □ | K25 | □ | K35 | □ | K45 | □ | K55 | ▪ | K65 | □ | Fifth | 50 KW |
| | | | | | | | | | | | | | interface | |
| | K16 | □ | K26 | □ | K36 | □ | K46 | □ | K56 | □ | K66 | ▪ | Sixth | 60 KW |
| | | | | | | | | | | | | | interface | |

The maximum charging power of the plurality of charging interfaces is equal to the sum of the maximum charging power of the plurality of power modules within the charging rectifier cabinet

In the embodiment, when all six charging guns 22 are connected to the energy storage units 30, and the rated charging powers of the energy storage units 30 that are connected to the first charging gun 221 to the sixth charging gun 226 are respectively less than 10 KW, 20 KW, 30 KW, 40 KW, 50 KW, and 60 KW. The power control unit 11 controls the controlled switch unit 122 to enable the first module 131 of the power distribution matrix circuit 12 to conduct with the first interface 1211 through a switch unit K11, the second module 132 to conduct with the second interface 1212 through a switch unit K22, the third module to conduct with the third interface 1213 through a switch unit K33, the fourth module to conduct with the fourth interface 1214 through a switch unit K44, the fifth module to conduct with the fifth interface 1215 through a switch unit K55, and the sixth module 136 to conduct with the sixth interface 1216 through a switch unit K66. In this way, the output power of the first interface 1211 and the first charging gun 221 is 10 KW, the output power of the same second interface 1212 and the second charging gun 222 is 20 KW, the output power of the third interface 1213 and the third charging gun 223 is 30 KW, the output power of the fourth interface 1214 and the fourth charging gun 224 is 40 KW, the output power of the fifth interface 1215 and the fifth charging gun 225 is 50 KW, and the output power of the sixth interface 1216 and the sixth charging gun 226 is 60 KW, which allows for the maximum efficiency of charging the energy storage unit 30 according to the number of energy storage unit 30 that are connected and the rated charging power of the energy storage unit 30, thereby ensuring that each energy storage unit 30 is charged at the rated charging power thereof to reduce a charging time of charging the energy storage unit 30.

### A Charging Rectifier Cabinet A of a Second Embodiment

Combining Table 2 and FIGS. 1 to 3, it is explained that when the demand and quantity of the rated charging power of the energy storage units 30 that are connected to the charging interface 121 are different, the control of the controlled switch unit 122 by the power control unit 11 is also different, that is, positions and quantities of the controlled switch unit 122 that are turned on are different. For example, Table 2.

TABLE 2
conduction state and charging power distribution table of
controlled switch unit of power distribution matrix circuit

| | Power module | | | | | | | | | | | | | Maximum | |
|---|---|---|---|---|---|---|---|---|---|---|---|---|---|---|---|
| | First | | Second | | Third | | Fourth | | Fifth | | Sixth | | | charging | |
| | module | | module | | module | | module | | module | | module | | Charging | power of | |
| | 10 KW | | 20 KW | | 30 KW | | 40 KW | | 50 KW | | 60 KW | | interface | charging gun | |
| Status of controlled | K11 | ▪ | K21 | ▪ | K31 | □ | K41 | □ | K51 | □ | K61 | □ | First | 30 | KW |
| switch unit | | | | | | | | | | | | | interface | | |
| □ non-conduction | K12 | □ | K22 | □ | K32 | □ | K42 | □ | K52 | □ | K62 | □ | Second | 0 | KW |
| ▪ conduction | | | | | | | | | | | | | interface | | |
| | K13 | □ | K23 | □ | K33 | ▪ | K43 | ▪ | K53 | □ | K63 | □ | Third | 70 | KW |
| | | | | | | | | | | | | | interface | | |
| | K14 | □ | K24 | □ | K34 | □ | K44 | □ | K54 | □ | K64 | □ | Fourth | 0 | KW |
| | | | | | | | | | | | | | interface | | |
| | K15 | □ | K25 | □ | K35 | □ | K45 | □ | K55 | ▪ | K65 | ▪ | Fifth | 110 | KW |
| | | | | | | | | | | | | | interface | | |
| | K16 | □ | K26 | □ | K36 | □ | K46 | □ | K56 | □ | K66 | □ | Sixth | 0 | KW |

interface

The maximum charging power of the plurality of charging interfaces is equal to the sum of the maximum charging power of the plurality of power modules within the charging rectifier cabinet

It can be seen from Table 2 that when the energy storage units 30 are only connected to the first charging gun 221, the third charging gun 223 and the fifth charging gun 225, and the other charging guns 22 are not connected to the energy storage units 30, and the rated charging power of the energy storage unit 30 that is connected to the first charging gun 221 is 30 KW, the rated charging power of the energy storage unit 30 that is connected to the third charging gun 223 is 70 KW, and the rated charging power of the energy storage unit 30 that is connected to the fifth charging gun 225 is 110 KW. The power control unit 11 controls the switching units K11 and K21 to be turned on, so that both the first module 131 and the second module 132 within the power distribution matrix circuit 12 are connected to the first interface 1211. The power control unit 11 controls the switching units K33 and K43 to be turned on, so that both the third module 133 and the fourth module 134 within the power distribution matrix circuit 12 are connected to the third interface 1213. The power control unit 11 controls the switching units K55 and K65 to be turned on, so that both the fifth module 135 and the sixth module 136 within the power distribution matrix circuit 12 are connected to the fifth interface 1215. In this way, the charging power output by the first interface 1211 and the first charging gun 221 is the sum of the maximum charging power of the first module 131 and the second module 132, which is 30 KW. Similarly, the output power of the third interface 1213 and the third charging gun 223 is 70 KW, the output power of the fifth interface 1215 and the fifth charging gun 225 is 110 KW, and the other charging interfaces 121 and the other charging guns 22 are not connected to the power module 13. Therefore, the output charging power of the other charging interfaces 121 and the other charging guns 22 is 0. By using the power control unit 11 to control the controlled switch units 122 based on the rated charging power of the energy storage unit 30, so that the plurality of energy storage units 30 can be charged with different combinations of maximum charging power to meet various charging requirements thereof.

From the above first and second embodiments, it can be seen that the total maximum charging power of the first module 131 to the sixth module 136 is 210 KW. When charging the six energy storage units 30 according to Table 1 and charging only the three energy storage units 30 that are connected according to Table 2, the sum of the rated charging power of the plurality of energy storage units 30 is 210 KW, which ensures to intelligently distribute the charging power of the energy storage units 30, and there is no excess or unused charging power thereof.

Of course, in the present disclosure, the number of power modules 13 and the number of charging interfaces 121 can also be other values, such as the number of power modules 13 and the number of charging interfaces 121 are respectively eight. As the number of power modules 13 increases, the number of controlled switches 123 that are controlled by the power control unit 11 increases. However, it is sufficient as long as the connection and control of the power distribution matrix circuit 12 of the present disclosure are met.

### A Charging Rectifier Cabinet A of a Third Embodiment

The most typical application of the present disclosure is that there are six power modules 13, all of which have the same maximum charging power Q of 60 KW. The charging rectifier cabinet A has six charging interfaces, and the charging unit B has six charging guns 22, which is specified in Table 3 for details.

TABLE 3
conduction state and charging power distribution table of
controlled switch unit of power distribution matrix circuit

| | Power module | | | | | | | | | | | | | Maximum | |
|---|---|---|---|---|---|---|---|---|---|---|---|---|---|---|---|
| | First | | Second | | Third | | Fourth | | Fifth | | Sixth | | | charging | |
| | module | | module | | module | | module | | module | | module | | Charging | power of | |
| | 60 KW | | 60 KW | | 60 KW | | 60 KW | | 60 KW | | 60 KW | | interface | charging gun | |
| Status of controlled | K11 | ▪ | K21 | ▪ | K31 | ▪ | K41 | □ | K51 | □ | K61 | □ | First | 180 | KW |
| switch unit | | | | | | | | | | | | | interface | | |
| □ non-conduction | K12 | □ | K22 | □ | K32 | □ | K42 | □ | K52 | □ | K62 | □ | Second | 0 | KW |
| ▪ conduction | | | | | | | | | | | | | interface | | |
| | K13 | □ | K23 | □ | K33 | □ | K43 | □ | K53 | □ | K63 | □ | Third | 0 | KW |
| | | | | | | | | | | | | | interface | | |
| | K14 | □ | K24 | □ | K34 | □ | K44 | ▪ | K54 | ▪ | K64 | □ | Fourth | 120 | KW |
| | | | | | | | | | | | | | interface | | |
| | K15 | □ | K25 | □ | K35 | □ | K45 | □ | K55 | □ | K65 | □ | Fifth | 0 | KW |
| | | | | | | | | | | | | | interface | | |
| | K16 | □ | K26 | □ | K36 | □ | K46 | □ | K56 | □ | K66 | ▪ | Sixth | 60 | KW |

interface

The maximum charging power of the plurality of charging interfaces is equal to the sum of the maximum charging power of the plurality of power modules within the charging rectifier cabinet, which is 360 KW.

At this time, when only the first charging gun 221, the fourth charging gun 224, and the sixth charging gun 226 are connected to the energy storage units 30 of the six charging guns 22, and the rated charging powers of the energy storage units 30 are different. For example, when the rated charging power of the energy storage unit 30 that is connected to the first charging gun 221 is 180 KW, the rated charging power of the energy storage unit 30 that is connected to the fourth charging gun 224 is 120 KW, and the rated charging power of the energy storage unit 30 that is connected to the sixth charging gun 226 is 60 KW, The power control unit 11 controls the switch units K11, K21, K31, K44, K54 and K66 to be turned on, as shown in Table 3. At this time, the maximum charging power output from the first charging gun 221, the fourth charging gun 224 and the sixth charging gun 226 are 180 KW, 120 KW, and 60 KW, respectively. The charging system 100 can ensure that each energy storage unit 30 that is connected obtains the maximum charging power, and intelligently distribution the charging power thereof.

### A Charging Rectifier Cabinet A of a Fourth Embodiment

Another typical application of the present disclosure is that: when only the first charging gun 221 of the six charging guns 22 is connected to the energy storage unit 30, and the maximum charging power of each charging module 13 is 60 KW. The rated charging power of the energy storage unit 30, that is, the maximum allowable charging power is 480 KW, which is specifically as shown in Table 4.

TABLE 4
conduction state and charging power distribution table of
controlled switch unit of power distribution matrix circuit

| | Power module | | | | | | | | | | | | | Maximum | |
|---|---|---|---|---|---|---|---|---|---|---|---|---|---|---|---|
| | First | | Second | | Third | | Fourth | | Fifth | | Sixth | | | charging | |
| | module | | module | | module | | module | | module | | module | | Charging | power of | |
| | 60 KW | | 60 KW | | 60 KW | | 60 KW | | 60 KW | | 60 KW | | interface | charging gun | |
| Status of controlled | K11 | ▪ | K21 | ▪ | K31 | ▪ | K41 | ▪ | K51 | ▪ | K61 | ▪ | First | 360 | KW |
| switch unit | | | | | | | | | | | | | interface | | |
| □ non-conduction | K12 | □ | K22 | □ | K32 | □ | K42 | □ | K52 | □ | K62 | □ | Second | 0 | KW |
| ▪ conduction | | | | | | | | | | | | | interface | | |
| | K13 | □ | K23 | □ | K33 | □ | K43 | □ | K53 | □ | K63 | □ | Third | 0 | KW |
| | | | | | | | | | | | | | interface | | |
| | K14 | □ | K24 | □ | K34 | □ | K44 | □ | K54 | □ | K64 | □ | Fourth | 0 | KW |
| | | | | | | | | | | | | | interface | | |
| | K15 | □ | K25 | □ | K35 | □ | K45 | □ | K55 | □ | K65 | □ | Fifth | 0 | KW |
| | | | | | | | | | | | | | interface | | |
| | K16 | □ | K26 | □ | K36 | □ | K46 | □ | K56 | □ | K66 | □ | Sixth | 0 | KW |

interface

The maximum charging power of the plurality of charging interfaces is equal to the sum of the maximum charging power of the plurality of power modules within the charging rectifier cabinet, which is 360 KW.

In the present disclosure, it can be seen that at this time, a group of switch signals C controls all six controlled switch units 122 in the same row that are connected to the first interface 1211 to be turned on, while all other controlled switch units 122 in the same charging rectifier cabinet A are non-conductive. At this time, the maximum charging power that can be obtained on the first interface 1211 and the first charging gun 221 is 60 KW*6=360 KW (wherein Q=60 KW, and N=6).

From the corresponding embodiment as shown in Table 4, it can be seen that the rated charging power of the energy storage unit 30 (480 KW>60 KW*6=360 KW) is already greater than the sum of the maximum charging power of all six charging modules 13 within a charging rectifier cabinet A. Therefore, in any case, the energy storage unit 30 can't reach the rated charging power with being charged by only one charging rectifier cabinet A, that is, the energy storage unit 30 can't be charged at the full power. For this reason, the present disclosure can have a plurality of charging rectifier cabinets A to solve the technical problem above mentioned.

### A Charging Connection Between a Plurality of Charging Rectifier Cabinets A and the Charging Unit B

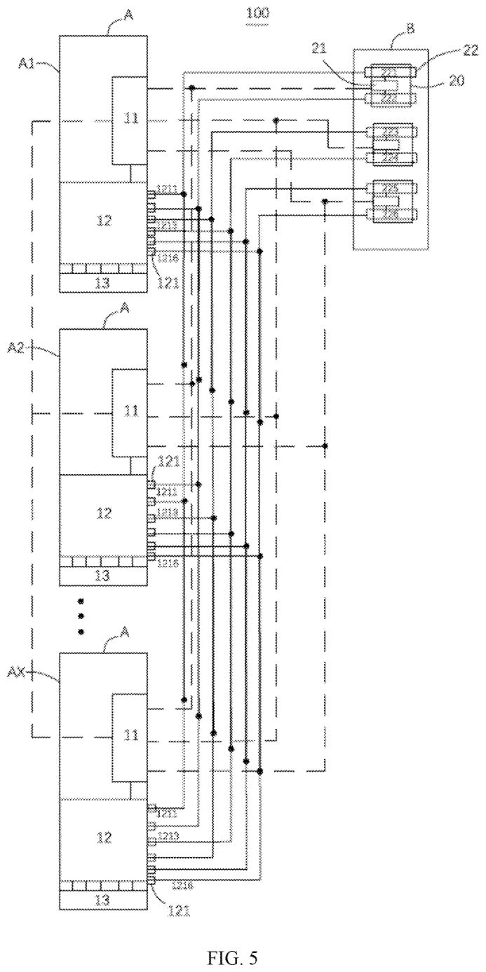

Referring to FIG. 5, in the present disclosure, the charging system 100 includes X charging rectifier cabinets A connected in parallel, wherein X is a natural number that is equal to and greater than 2. The charging connection relationship between the X charging rectifier cabinets A and the charging unit B is as follows: each charging gun 22 is connected to the X charging rectifier cabinets A, and connected to any charging interface 121 within the charging rectifier cabinets A.

When the charging system 100 includes the plurality of charging rectifier cabinets A, a difference between the plurality of charging rectifier cabinets A and only one charging rectifier cabinet A of the embodiment described above is that a charging connection way is different. When there is only one charging rectifier cabinet A, one of the N charging guns 22 within the charging unit B is connected to one of the N charging interfaces 121 within charging rectifier cabinet A, while in the embodiment with the plurality of charging rectifier cabinets A, each charging gun 22 is connected to the X charging interfaces 121, and each of the X charging interfaces 121 comes from one of the charging rectifier cabinets A, which is specified as follows below.

The X charging rectifier cabinets A are defined as a first rectifier cabinet A₁, a second rectifier cabinet A₂, and until to an X-th rectifier cabinet A_{X}. Therefore, the first charging gun 221 is connected to the first interface 1211 within the first rectifier cabinet A₁, the first charging gun 221 is connected to the first interface 1211 within the second rectifier cabinet A₂, and until to the first interface 1211 within the X-th rectifier cabinet A_{X}. The second charging gun 222 is connected to the second interface 1212 within the first rectifier cabinet A₁, and the second charging gun 222 is connected to the second interface 1212 within the second rectifier cabinet A₂ until the second charging gun 222 is connected to the second interface 1212 within the X-th rectifier cabinet A_{X}; and so on until the N-th charging gun is connected to the N-th interface within the first rectifier cabinet A₁, and the N-th charging gun is connected to the N-th interface within the second rectifier cabinet A₂, until the N-th charging gun is connected to the N-th interface within the X-th rectifier cabinet A_{X}.

For one charging gun 22, it is connected to each charging rectifier cabinet A, but it is only connected to one charging interface 121 of each charging rectifier cabinet A. For the charging interface 121, each of the X charging interfaces 121 that are connected to the same charging gun 22 is not connected to any other charging gun 22.

### A Control Connection Between the Plurality of Charging Rectifier Cabinets A and the Charging Unit B

Each charging control unit 21 is electrically connected to the X power control units 11 of the X charging rectifier cabinets A, and the X power control units 11 of the X charging rectifier cabinets A are electrically connected to each other. At least one of the X power control units 11 is configured to generate X groups of switch signals C, each group of switch signals C configured to control N*N switch control signals C1 within the power distribution matrix circuit 12.

In the present disclosure, The X group switch signal C can be generated by one of the X power control units 11, and then the X group of switch signal C are sent to all of the X power control units 11. Each power control unit 11 selects one group of switch signals C from the X groups of switch signals C to control the power distribution matrix circuit 12, wherein the group of switch signals C that are selected correspond to the charging rectifier cabinet A where the current power control unit 11 is arranged, or
each group of switch signals C is generated by the power control unit 11, and the X power control units 11 communicate with each other to determine the group of switch signals C that is to be generated by each of the X power control units 11. And then, each power control unit 11 sends the group of switch signals C that is generated by itself to the corresponding power distribution matrix circuit 12, and each of the power distribution matrix circuits 12 is configured to control the controlled switch units 12 in a one-to-one correspondence to be turned on or turned off by using the plurality of groups of switch signals C. Each group of switch signals C includes the N*N switch control signals C1, as shown in FIG. 3. Each switch control signal C1 is configured to control the conduction or non-conduction of a pair of positive switch b1 and negative switch b2.

In the present disclosure, each charging control unit 21 sends the detected charging parameters of the charging gun 22 to each charging rectifier cabinet A, and the X charging rectifier cabinets A also communicate with each other to determine the rated charging power requirements of all energy storage units 30 that are connected to the N charging guns 22, for generating a power distribution strategy that includes the X groups of switch signals C, and then sending each group of switch signals C to the power distribution matrix circuit 12 within each charging rectifier cabinet A in a one-to-one correspondence.

A difference between the embodiment with the X charging rectifier cabinets A and only one charging rectifier cabinet A described above is that a control connection way is different. When there is only one charging rectifier cabinet A, the charging control unit 21 within the charging unit B is electrically connected to the power control unit 11 within the charging rectifier cabinet A. When there are X charging rectifier cabinets A, all charging control units 21 within the charging unit B need to be electrically connected to the power control units 11 within each charging rectifier cabinet A, and the X power control units 11 within the X charging rectifier cabinets A also need to be electrically connected to each other.

In addition, at least one of the X power control units 11 generates the X groups of switch signals C. In the embodiment with only one charging rectifier cabinet A, the power control unit 11 only generates a group of switch signals C, and the conduction control of the controlled switch unit 12 within a power distribution matrix circuit 12 can be achieved through the only one group of switch signals C.

### A Plurality of Charging Rectifier Cabinets A of a First Embodiment

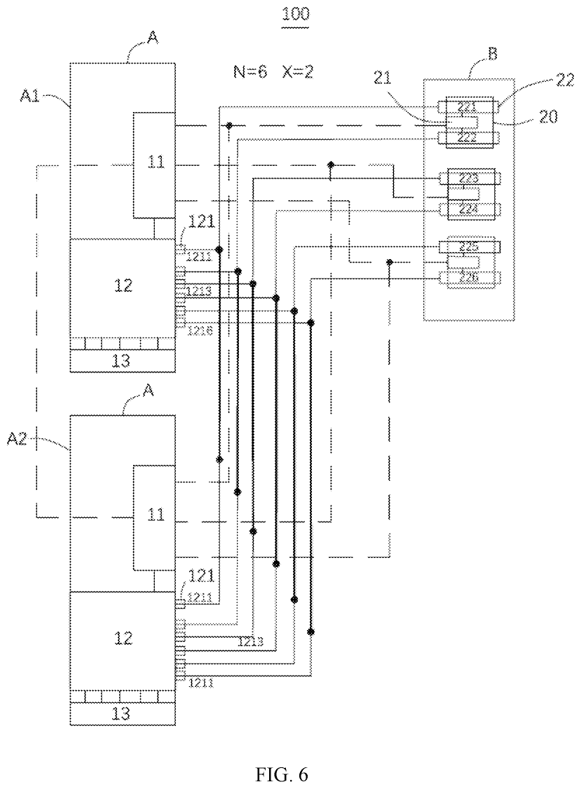

The first embodiment is an improvement based on the single charging rectifier cabinet A of the fourth embodiment mentioned above, and further description is provided. As shown in FIG. 6, in the embodiment, X is equal to 2, and there are two groups of switch signal C. There are two charging rectifier cabinets that are respectively taken as a first rectifier cabinet A₁ and a second rectifier cabinet A₂.

In the embodiment, the first charging gun 221 is connected to the first interface 1211 of the first rectifier cabinet A₁ and the first interface 1211 of the second rectifier cabinet A₂, respectively. The second charging gun 222 is connected to the second interface 1212 of the first rectifier cabinet A₁ and the second interface 1212 of the second rectifier cabinet A₂, respectively. The third charging gun 223 is connected to the third interface 1213 of the first rectifier cabinet A₁ and the third interface 1213 of the second rectifier cabinet A₂, respectively. And so on, until the sixth charging gun 226 is connected to the sixth interface 1216 of the first rectifier cabinet A₁ and the sixth interface 1216 of the second rectifier cabinet A₂, respectively.

In the embodiment, the controlled switch units 122 of the two power distribution matrix circuits 12 is controlled as shown in Table 5, which is specified in details below.

TABLE 5
conduction status and charging power distribution table of two groups
of controlled switch units within two charging rectifier cabinets

| Power module | | | | | | Charging | maximum |
|---|---|---|---|---|---|---|---|
| First | Second | Third | Fourth | Fifth | Sixth | interface | charging |
| module | module | module | module | module | module | and | power of |
| 60 KW | 60 KW | 60 KW | 60 KW | 60 KW | 60 KW | charging gun | charging gun |

Status of controlled switch unit □ non-conduction ▪ conduction

| | | | | | | | | | | | | | | | |
|---|---|---|---|---|---|---|---|---|---|---|---|---|---|---|---|
| First | K11 | ▪ | K21 | ▪ | K31 | ▪ | K41 | ▪ | K51 | ▪ | K61 | ▪ | First | 360 | KW |
| charging | | | | | | | | | | | | | interface | | |
| rectifier | | | | | | | | | | | | | First | | |
| cabinet A1 | | | | | | | | | | | | | charging | | |
| | | | | | | | | | | | | | gun | | |
| | K12 | □ | K22 | □ | K32 | □ | K42 | □ | K52 | □ | K62 | □ | Second | 0 | KW |
| | | | | | | | | | | | | | interface | | |
| | | | | | | | | | | | | | Second | | |
| | | | | | | | | | | | | | charging | | |
| | | | | | | | | | | | | | gun | | |
| | K13 | □ | K23 | □ | K33 | □ | K43 | □ | K53 | □ | K63 | □ | Third | 0 | KW |
| | | | | | | | | | | | | | interface | | |
| | | | | | | | | | | | | | Third | | |
| | | | | | | | | | | | | | charging | | |
| | | | | | | | | | | | | | gun | | |
| | K14 | □ | K24 | □ | K34 | □ | K44 | □ | K54 | □ | K64 | □ | Fourth | 0 | KW |
| | | | | | | | | | | | | | interface | | |
| | | | | | | | | | | | | | Fourth | | |
| | | | | | | | | | | | | | charging | | |
| | | | | | | | | | | | | | gun | | |
| | K15 | □ | K25 | □ | K35 | □ | K45 | □ | K55 | □ | K65 | □ | Fifth | 0 | KW |
| | | | | | | | | | | | | | interface | | |
| | | | | | | | | | | | | | Fifth | | |
| | | | | | | | | | | | | | charging | | |
| | | | | | | | | | | | | | gun | | |
| | K16 | □ | K26 | □ | K36 | □ | K46 | □ | K56 | □ | K66 | □ | Sixth | 0 | KW |
| | | | | | | | | | | | | | interface | | |
| | | | | | | | | | | | | | Sixth | | |
| | | | | | | | | | | | | | charging | | |
| | | | | | | | | | | | | | gun | | |
| Second | K11 | ▪ | K21 | ▪ | K31 | □ | K41 | □ | K51 | □ | K61 | □ | First | 120 | KW |
| charging | | | | | | | | | | | | | interface | | |
| rectifier | | | | | | | | | | | | | First | | |
| cabinet A2 | | | | | | | | | | | | | charging | | |
| | | | | | | | | | | | | | gun | | |
| | K12 | □ | K22 | □ | K32 | ▪ | K42 | □ | K52 | □ | K62 | □ | Second | 60 | KW |
| | | | | | | | | | | | | | interface | | |
| | | | | | | | | | | | | | Second | | |
| | | | | | | | | | | | | | charging | | |
| | | | | | | | | | | | | | gun | | |
| | K13 | □ | K23 | □ | K33 | □ | K43 | □ | K53 | □ | K63 | □ | Third | 0 | KW |
| | | | | | | | | | | | | | interface | | |
| | | | | | | | | | | | | | Third | | |
| | | | | | | | | | | | | | charging | | |
| | | | | | | | | | | | | | gun | | |
| | K14 | □ | K24 | □ | K34 | □ | K44 | ▪ | K54 | ▪ | K64 | □ | Fourth | 120 | KW |
| | | | | | | | | | | | | | interface | | |
| | | | | | | | | | | | | | Fourth | | |
| | | | | | | | | | | | | | charging | | |
| | | | | | | | | | | | | | gun | | |
| | K15 | □ | K25 | □ | K35 | □ | K45 | □ | K55 | □ | K65 | □ | Fifth | 0 | KW |
| | | | | | | | | | | | | | interface | | |
| | | | | | | | | | | | | | Fifth | | |
| | | | | | | | | | | | | | charging | | |
| | | | | | | | | | | | | | gun | | |
| | K16 | □ | K26 | □ | K36 | □ | K46 | □ | K56 | □ | K66 | ▪ | Sixth | 60 | KW |

interface
Sixth
charging
gun

In the embodiment, the first rectifier cabinet A₁ provides 360 KW of charging power to the first charging gun 221, and the second rectifier cabinet A₂ provides 120 KW of charging power to the first charging gun 221. Therefore, the maximum charging power of the first charging gun 221 is: 360 KW+120 KW=480 KW, which is exactly equal to the rated charging power of the energy storage unit 30. Therefore, the energy storage unit 30 is charged at the full power of the rated charging power thereof. In addition, the energy storage units 30 that are connected to the fourth charging gun 224 and the sixth charging gun 226 respectively obtains a maximum charging power of 120 KW and a maximum charging power of 60 KW. In this way, the total maximum charging power that is obtained from the first charging gun 221 to the sixth charging gun 226 is: 480 KW+60 KW+120 KW+60 KW=720 KW.

In the embodiment, the maximum charging power that can be output by the first charging gun 221 corresponds to j power modules 13 that are conducted within the six power modules 13 that are connected to the first interface 1211, wherein j is a natural number and j=8. Of course, the maximum charging power that can be output by the second charging gun 222 corresponds to j power modules 13 that are conducted within the six power modules 13 that are connected to the second interface 1212, wherein j=1. For the third charging gun 223, the third charging gun 223 is non-conductive with all of the six power modules 13, that is, that any one of the charging guns 22 is non-conductive with all power modules 13 of the charging system 100.

### A Plurality of Charging Rectifier Cabinets of a Second Embodiment

The second embodiment is an improvement based on the plurality of charging rectifier cabinets A of the first embodiment mentioned above, a difference between the first and second embodiments is that the rated charging power of the energy storage unit 30 is 780 KW, and the energy storage unit 30 is connected to the first charging gun 221, which is specified in details below.

In the embodiment, X is equal to 2, and there are two groups of switch signals C. The two charging rectifier cabinets A are respectively taken as a first rectifier cabinet A₁ and a second rectifier cabinet A₂, as shown in Table 6 below.

TABLE 6
conduction status and charging power distribution table of two groups
of controlled switch units within two charging rectifier cabinets

| Power module | | | | | | Charging | maximum |
|---|---|---|---|---|---|---|---|
| First | Second | Third | Fourth | Fifth | Sixth | interface | charging |
| module | module | module | module | module | module | and | power of |
| 60 KW | 60 KW | 60 KW | 60 KW | 60 KW | 60 KW | charging gun | charging gun |

Status of controlled switch unit □ non-conduction ▪ conduction

| | | | | | | | | | | | | | | | |
|---|---|---|---|---|---|---|---|---|---|---|---|---|---|---|---|
| First | K11 | ▪ | K21 | ▪ | K31 | ▪ | K41 | ▪ | K51 | ▪ | K61 | ▪ | First | 360 | KW |
| charging | | | | | | | | | | | | | interface | | |
| rectifier | | | | | | | | | | | | | First | | |
| cabinet A1 | | | | | | | | | | | | | charging | | |
| | | | | | | | | | | | | | gun | | |
| | K12 | □ | K22 | □ | K32 | □ | K42 | □ | K52 | □ | K62 | □ | Second | 0 | KW |
| | | | | | | | | | | | | | interface | | |
| | | | | | | | | | | | | | Second | | |
| | | | | | | | | | | | | | charging | | |
| | | | | | | | | | | | | | gun | | |
| | K13 | □ | K23 | □ | K33 | □ | K43 | □ | K53 | □ | K63 | □ | Third | 0 | KW |
| | | | | | | | | | | | | | interface | | |
| | | | | | | | | | | | | | Third | | |
| | | | | | | | | | | | | | charging | | |
| | | | | | | | | | | | | | gun | | |
| | K14 | □ | K24 | □ | K34 | □ | K44 | □ | K54 | □ | K64 | □ | Fourth | 0 | KW |
| | | | | | | | | | | | | | interface | | |
| | | | | | | | | | | | | | Fourth | | |
| | | | | | | | | | | | | | charging | | |
| | | | | | | | | | | | | | gun | | |
| | K15 | □ | K25 | □ | K35 | □ | K45 | □ | K55 | □ | K65 | □ | Fifth | 0 | KW |
| | | | | | | | | | | | | | interface | | |
| | | | | | | | | | | | | | Fifth | | |
| | | | | | | | | | | | | | charging | | |
| | | | | | | | | | | | | | gun | | |
| | K16 | □ | K26 | □ | K36 | □ | K46 | □ | K56 | □ | K66 | □ | Sixth | 0 | KW |
| | | | | | | | | | | | | | interface | | |
| | | | | | | | | | | | | | Sixth | | |
| | | | | | | | | | | | | | charging | | |
| | | | | | | | | | | | | | gun | | |
| Second | K11 | ▪ | K21 | ▪ | K31 | ▪ | K41 | ▪ | K51 | ▪ | K61 | ▪ | First | 120 | KW |
| charging | | | | | | | | | | | | | interface | | |
| rectifier | | | | | | | | | | | | | First | | |
| cabinet A2 | | | | | | | | | | | | | charging | | |
| | | | | | | | | | | | | | gun | | |
| | K12 | □ | K22 | □ | K32 | □ | K42 | □ | K52 | □ | K62 | □ | Second | 60 | KW |
| | | | | | | | | | | | | | interface | | |
| | | | | | | | | | | | | | Second | | |
| | | | | | | | | | | | | | charging | | |
| | | | | | | | | | | | | | gun | | |
| | K13 | □ | K23 | □ | K33 | □ | K43 | □ | K53 | □ | K63 | □ | Third | 0 | KW |
| | | | | | | | | | | | | | interface | | |
| | | | | | | | | | | | | | Third | | |
| | | | | | | | | | | | | | charging | | |
| | | | | | | | | | | | | | gun | | |
| | K14 | □ | K24 | □ | K34 | □ | K44 | □ | K54 | □ | K64 | □ | Fourth | 120 | KW |
| | | | | | | | | | | | | | interface | | |
| | | | | | | | | | | | | | Fourth | | |
| | | | | | | | | | | | | | charging | | |
| | | | | | | | | | | | | | gun | | |
| | K15 | □ | K25 | □ | K35 | □ | K45 | □ | K55 | □ | K65 | □ | Fifth | 0 | KW |
| | | | | | | | | | | | | | interface | | |
| | | | | | | | | | | | | | Fifth | | |
| | | | | | | | | | | | | | charging | | |
| | | | | | | | | | | | | | gun | | |
| | K16 | □ | K26 | □ | K36 | □ | K46 | □ | K56 | □ | K66 | □ | Sixth | 60 | KW |

interface
Sixth
charging
gun

In the embodiment, the first interface 1211 of the first rectifier cabinet A₁ provides 360 KW of charging power to the first charging gun 221, and the first charging gun 1211 of the second rectifier cabinet A₂ provides 360 KW of charging power to the first charging gun 221. Therefore, the maximum charging power obtained by the first charging gun 221 is: 360 KW+360 KW=720 KW. Although 720 KW of charging power is still lower than the rated charging power of 780 KW of the energy storage unit 30 that is connected to the first charging gun 221, the maximum possible charging capacity of the energy storage unit 30 has been met. At this time, the two charging rectifier cabinets A are fully loaded and configured to charge the energy storage unit 30 at full power. The charging power of 720 KW is also the maximum charging power of the two charging rectifier cabinets A. Of course, according to the method of the present disclosure, an additional charging rectifier cabinet A can be added, thereby providing three rectifier cabinets A to charge the energy storage unit 30. At this time, the maximum charging power that the three charging rectifier cabinets A can provide is: 360*3=1080 KW, thereby fully covering the rated charging power of 780 KW of the energy storage unit 30.

In the embodiment, the maximum charging power that can be output by the first charging gun 221 corresponds to j power modules 13 that are conducted on the first interface 1211, wherein j is a natural number, and j=12, in this way, the maximum value of j is N*X, which means that all power modules 13 within the X charging rectifier cabinets A are conducted for supplying power to the first charging gun. Therefore, according to the first and second embodiments of the plurality of charging rectifier cabinets A, it can be seen that: a) at least one of the charging guns 22 are conductive with the j power modules 13, and j is a natural number, and satisfies: 1≤j≤N*X.

### A Plurality of Charging Rectifier Cabinets A of a Third Embodiment

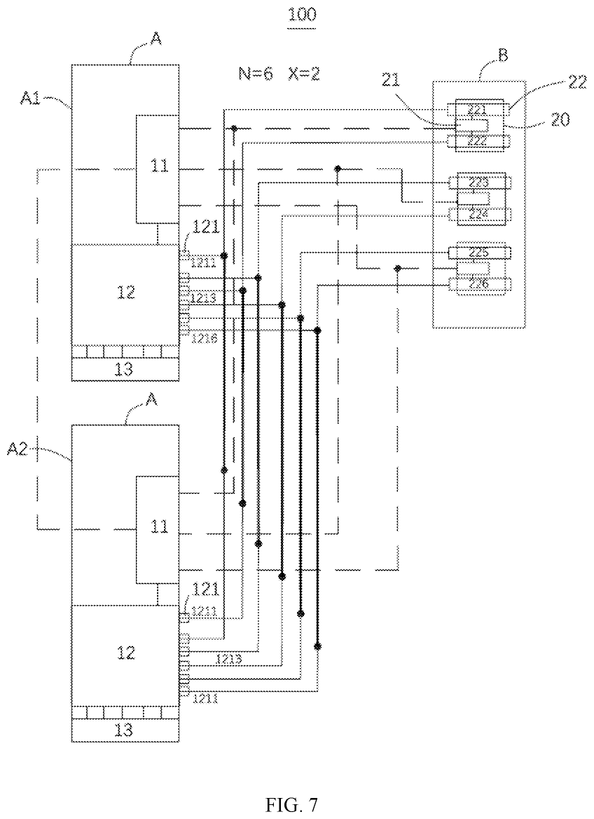

Referring to FIG. 7, The third embodiment is an improvement based on the plurality of charging rectifier cabinets A of the first embodiment mentioned above, which is further described in details below.

In the embodiment, the charging gun 22 is not sequentially connected to the charging interfaces 121 of the two charging rectifier cabinets A, or in other words, the charging gun 22 is not connected to the charging interfaces 121 in the same sequential position as the first rectifier cabinet A1 and the second rectifier cabinet A2. Instead, the charging gun 22 is connected to any one of the charging interfaces 121 of the first rectifier cabinet A1 and any one of the charging interfaces 121 of the second rectifier cabinet A2.

In the embodiment, an example of the connection between the charging gun 22 and the charging interface 121 is as follows.

The first charging gun 221 is connected to the first interface 1211 of the first rectifier cabinet A₁, and the first charging gun 221 is connected to the second interface 1212 of the second rectifier cabinet A₂.

The second charging gun 222 is connected to the third interface 1213 of the first rectifier cabinet A₁, and the second charging gun 222 is connected to the first interface 1211 of the second rectifier cabinet A₂.

The third charging gun 223 is connected to the second interface 1212 of the first rectifier cabinet A₁, and the third charging gun 223 is connected to the third interface 1213 of the second rectifier cabinet A₂.

The fourth charging gun 224 is connected to the fourth interface 1214 of the first rectifier cabinet A₁, and the fourth interface 1214 of the second rectifier cabinet A₂, respectively.

The fifth charging gun 225 is connected to the fifth interface 1215 of the first rectifier cabinet A₁, and the fifth interface 1215 of the second rectifier cabinet A₂, respectively.

The sixth charging gun 226 is connected to the sixth interface 1216 of the first rectifier cabinet A₁, and the sixth interface 1216 of the second rectifier cabinet A₂, respectively.

In the embodiment, the controlled switch unit 122 of the two power distribution matrix circuits 12 is controlled as shown in Table 6, which is specifically described in details below.

TABLE 7
conduction status and charging power distribution table of two groups
of controlled switch units within two charging rectifier cabinets

| Power module | | | | | | Charging | maximum |
|---|---|---|---|---|---|---|---|
| First | Second | Third | Fourth | Fifth | Sixth | interface | charging |
| module | module | module | module | module | module | and | power of |
| 60 KW | 60 KW | 60 KW | 60 KW | 60 KW | 60 KW | charging gun | charging gun |

Status of controlled switch unit □ non-conduction ▪ conduction

| | | | | | | | | | | | | | | | |
|---|---|---|---|---|---|---|---|---|---|---|---|---|---|---|---|
| First | K11 | ▪ | K21 | □ | K31 | □ | K41 | □ | K51 | □ | K61 | □ | First | 180 | KW |
| charging | | | | | | | | | | | | | interface | | |
| rectifier | | | | | | | | | | | | | First | | |
| cabinet A1 | | | | | | | | | | | | | charging | | |
| | | | | | | | | | | | | | gun | | |
| | K12 | □ | K22 | □ | K32 | □ | K42 | ▪ | K52 | □ | K62 | □ | Second | 120 | KW |
| | | | | | | | | | | | | | interface | | |
| | | | | | | | | | | | | | Second | | |
| | | | | | | | | | | | | | charging | | |
| | | | | | | | | | | | | | gun | | |
| | K13 | □ | K23 | □ | K33 | □ | K43 | □ | K53 | ▪ | K63 | □ | Third | 60 | KW |
| | | | | | | | | | | | | | interface | | |
| | | | | | | | | | | | | | Third | | |
| | | | | | | | | | | | | | charging | | |
| | | | | | | | | | | | | | gun | | |
| | K14 | □ | K24 | □ | K34 | □ | K44 | □ | K54 | □ | K64 | □ | Fourth | 0 | KW |
| | | | | | | | | | | | | | interface | | |
| | | | | | | | | | | | | | Fourth | | |
| | | | | | | | | | | | | | charging | | |
| | | | | | | | | | | | | | gun | | |
| | K15 | □ | K25 | □ | K35 | □ | K45 | □ | K55 | □ | K65 | □ | Fifth | 0 | KW |
| | | | | | | | | | | | | | interface | | |
| | | | | | | | | | | | | | Fifth | | |
| | | | | | | | | | | | | | charging | | |
| | | | | | | | | | | | | | gun | | |
| | K16 | □ | K26 | □ | K36 | □ | K46 | □ | K56 | □ | K66 | □ | Sixth | 0 | KW |
| | | | | | | | | | | | | | interface | | |
| | | | | | | | | | | | | | Sixth | | |
| | | | | | | | | | | | | | charging | | |
| | | | | | | | | | | | | | gun | | |
| Second | K11 | ▪ | K21 | ▪ | K31 | □ | K41 | □ | K51 | □ | K61 | □ | First | 60 | KW |
| charging | | | | | | | | | | | | | interface | | |
| rectifier | | | | | | | | | | | | | First | | |
| cabinet A2 | | | | | | | | | | | | | charging | | |
| | | | | | | | | | | | | | gun | | |
| | K12 | □ | K22 | □ | K32 | ▪ | K42 | □ | K52 | □ | K62 | □ | Second | 120 | KW |
| | | | | | | | | | | | | | interface | | |
| | | | | | | | | | | | | | Second | | |
| | | | | | | | | | | | | | charging | | |
| | | | | | | | | | | | | | gun | | |
| | K13 | □ | K23 | □ | K33 | □ | K43 | □ | K53 | □ | K63 | □ | Third | 0 | KW |
| | | | | | | | | | | | | | interface | | |
| | | | | | | | | | | | | | Third | | |
| | | | | | | | | | | | | | charging | | |
| | | | | | | | | | | | | | gun | | |
| | K14 | □ | K24 | □ | K34 | □ | K44 | ▪ | K54 | ▪ | K64 | □ | Fourth | 120 | KW |
| | | | | | | | | | | | | | interface | | |
| | | | | | | | | | | | | | Fourth | | |
| | | | | | | | | | | | | | charging | | |
| | | | | | | | | | | | | | gun | | |
| | K15 | □ | K25 | □ | K35 | □ | K45 | □ | K55 | □ | K65 | □ | Fifth | 0 | KW |
| | | | | | | | | | | | | | interface | | |
| | | | | | | | | | | | | | Fifth | | |
| | | | | | | | | | | | | | charging | | |
| | | | | | | | | | | | | | gun | | |
| | K16 | □ | K26 | □ | K36 | □ | K46 | □ | K56 | □ | K66 | ▪ | Sixth | 60 | KW |

interface
Sixth
charging
gun

In the embodiment, the first interface 1211 of the first rectifier cabinet A₁ provides 180 KW of charging power to the first charging gun 221, the second interface 1212 of the first rectifier cabinet A₁ provides 60 KW of charging power to the third charging gun 223, and the third interface 1213 of the first rectifier cabinet A₁ provides 120 KW of charging power to the second charging gun 222.

The first interface 1211 of the second rectifier cabinet A₂ provides 120 KW of charging power to the second charging gun 222, the second interface 1212 of the second rectifier cabinet A₂ provides 60 KW of charging power to the first charging gun 222, the fourth interface 1214 of the second rectifier cabinet A₂ provides 120 KW of charging power to the fourth charging gun 224, and the sixth interface 1216 of the second rectifier cabinet A₂ provides 60 KW of charging power to the sixth charging gun 226.

Therefore, in the embodiment, the maximum charging power of the first charging gun 221 is: 180 KW+60 KW=240 KW, the maximum charging power of the second charging gun 222 is: 120 KW+120 KW=240 KW, the maximum charging power of the third charging gun 223 is: 60 KW+0 KW=60 KW, the maximum charging power of the fourth charging gun 224 is: 0 KW+120 KW=120 KW, the maximum charging power of the 5th charging gun 225 is: 0 KW+0 KW-0 KW, and the maximum charging power of the 6th charging gun 226 is: 0 KW+60 KW=60 KW.

The total maximum charging power obtained by the first charging gun 221 to the sixth charging gun 226 in the embodiment is: 240 KW+240 KW+60 KW+120 KW+0 KW+0 KW+60 KW=720 KW.

According to the disclosure and teachings in the above specification, for those ordinary skilled in the art of the present disclosure, all modifications, equivalent substitutions and improvements to the aforementioned embodiments can be made within the spirit and principles of the present disclosure. Therefore, the present disclosure is not intended to limit the specific embodiments disclosed and described above, and some modifications and improvements to the present disclosure should also fall within the scope of protection of the claims of the present disclosure. Furthermore, some specific terms are used in the above specification are only for conveniently describing the present disclosure, rather than being intended to limit the present disclosure.

What is claimed is:

1. A charging system with multiple charging rectifier cabinets parallel connected thereof comprising:
X charging rectifier cabinets, wherein X is a natural number and equal to and greater than 2; each of the X charging rectifier cabinets comprising a power control unit, a power distribution matrix circuit and N power modules, wherein N is a natural number and equal to and greater than 2; the power distribution matrix circuit electrically connected to the power control unit, and the N power modules configured to supply a charging power to the charging system; the power distribution matrix circuit comprising N charging interfaces and a plurality of controlled switch units, the N charging interfaces connected to the N power modules via the plurality of controlled switch units, the plurality of controlled switch units arranged in an N*N matrix, each of the N charging interfaces connected to the N power modules via the N controlled switch units in a row, and each of the N power modules connected to the N charging interfaces via the N controlled switch units in a column, each controlled switch unit arranged at a connection point of each row and column of the N*N matrix, and configured to control the power module in a current column to conduct with the charging interface in a current row; the power control unit configured to real-time control the plurality of controlled switch units to be turned on or turned off, so as to adjust the number of power modules that are conducted with each charging interface;
a changing unit electrically connected to the X charging rectifier cabinets and comprising a plurality of charging terminals, a charging control unit and a charging gun arranged within each of the plurality of charging terminals, wherein there are N charging guns arranged in the changing unit; and wherein in the same charging terminal, the charging control unit is electrically connected to the charging gun, and the charging control unit is configured to detect the charging parameters of the charging gun in real time; and wherein
each of the N charging guns is connected to the X charging rectifier cabinets, and connected to any charging interface within each of the X charging rectifier cabinets; and wherein
each of the plurality of charging control units is electrically connected to the X power control units of the X charging rectifier cabinets, and the X power control units that are arranged in the X charging rectifier cabinets are electrically connected to each other; and wherein
the charging control unit is configured to send the detected charging parameters of each charging gun to the power control unit, at least one of the X power control units is configured to generate X groups of switch signals based on the charging parameters and send each group of switch signals one-to-one to the power distribution matrix circuit that is within each of the X charging rectifier cabinets; and wherein each group of switch signals is configured to control the plurality of controlled switch units that is within each charging rectifier cabinet to be turned on or turned off, so that the N power modules within each charging rectifier cabinet are conductive or non-conductive with the charging gun; and wherein
under the control of the X groups of switch signals, the X power distribution matrix circuits is configured to enable the N charging guns to meet at least one of the following requirements:
a) at least one of the N charging guns is conducted with j power modules, wherein j is a natural number that satisfies: 1≤j≤N*X; and
b) any of the N charging guns is non-conductive with all of the N*X power modules of the charging system.

2. The charging system as claimed in claim 1, wherein each group of switch signals has a plurality of switch control signals, each of the plurality of switch control signals configured to control one of the plurality of controlled switch units to be turned on or turned off.

3. The charging system according to claim 2, wherein in the same charging rectifier cabinet and at the same time, only one of the N controlled switch units that are arranged in the same column is turned on, and the number of controlled switch units that are conducted in the same row is equal to the number of power modules that are conducted in that row.

4. The charging system as claimed in claim 3, wherein the charging gun is connected to an energy storage unit to charge the energy storage unit, the charging parameters comprising a rated charging power of the energy storage unit that is connected to the charging gun, a current charging voltage and a current charging current of the charging gun that is connected to the energy storage unit.

5. The charging system as claimed in claim 4, wherein the at least one of the X power control units generates the X groups of switch signals based on the number of energy storage units that are connected to the N charging guns and the rated charging power of each energy storage unit, so that the charging gun charges the energy storage unit according to the rated charging power required by the energy storage unit.

6. The charging system as claimed in claim 1, wherein each of rated charging powers of the N power modules is the same, which is taken as Q, and the maximum charging power output by any charging interface within the power distribution matrix circuit is N*Q.

7. The charging system as claimed in claim 6, wherein N is equal to 6, X is equal to 2, and Q is equal to 60 KW, wherein the maximum charging power of the charging system is 720 KW, and the maximum charging power of each charging gun is 720 KW.

8. The charging system as claimed in claim 2, wherein each power module comprises a charging positive electrode and a charging negative electrode, each charging interface comprising a positive terminal and a negative terminal, each charging gun electrically connected to both the positive terminal and the negative terminal, wherein when the charging gun is connected to an energy storage unit, the positive terminal and the negative terminal that are connected to the charging gun are conductive with each other; and wherein each controlled switch unit comprises a positive switch and a negative switch, the charging positive electrode is connected to the positive terminal through the positive switch, and the charging negative electrode is connected to the negative terminal through the negative switch; and wherein when both the positive switch and the negative switch of each controlled switch unit are turned on, the power module corresponding to the controlled switch unit is electrically connected to the charging interface.

9. The charging system as claimed in claim 8, wherein each group of switch signals comprises N*N switch control signals, each of the N*N switch control signals configured to control synchronous conduction or non-conduction of both the positive switch and the negative switch of a corresponding controlled switch unit.
